(19) United States
(12) Patent Application Publication
(10) Pub. No.: US 2026/0153593 A1
(43) Pub. Date: Jun. 4, 2026

(54) Electronic device with interference protection mechanism

(71) Applicant: MEDIATEK INC., Hsinchu City (TW)

(72) Inventors: Ting-Hsiang Wang, Hsinchu City (TW); I-Ying Liu, Hsinchu City (TW); Chun-Kai Wang, Hsinchu City (TW); Jun-Shen Chen, Hsinchu City (TW)

(73) Assignee: MEDIATEK INC., Hsinchu City (TW)

(21) Appl. No.: 19/090,342

(22) Filed: Mar. 25, 2025

Related U.S. Application Data
(60) Provisional application No. 63/727,621, filed on Dec. 3, 2024.

(51) Int. Cl. G01S 7/02; H04W 16/14; H04W 88/06

(52) U.S. Cl. CPC G01S 7/0235; H04W 16/14; H04W 88/06

(57) ABSTRACT

An electronic device includes a first communication module operating in compliance with a first wireless communication protocol and a second communication module operating in compliance with a second wireless communication protocol. The first communication module transmits a protection frame and suspends performance of at least one radio activity after transmitting the protection frame. A duration field of the protection frame is set based on a predetermined duration determined according to a time required for preforming one or more radio activities of the second communication module. The second communication module performs at least a transmitting activity within the predetermined duration after the first communication module has transmitted the protection frame.

### CROSS REFERENCE TO RELATED APPLICATIONS

This application claims the benefit of U.S. Provisional Application No. 63/727,621, filed on Dec, 3, 2024. The content of the application is incorporated herein by reference.

### BACKGROUND

Radar technology is increasingly being applied in smart home appliances, especially millimeter-wave radar technology. This technology uses millimeter-wave signals for detection and imaging, characterized by high accuracy, high resolution, and high reliability.

In smart home appliances, millimeter-wave radar technology can achieve various functions such as human presence sensing, gesture sensing, non-contact health monitoring, . . . etc. These applications not only enhance the intelligence level of household appliances but also improve the quality and convenience of users'lives.

Therefore, advancing the performance of radar technology is a subject worthy of exploration.

### SUMMARY

According to an embodiment of the invention, an electronic device comprises a first communication module operating in compliance with a first wireless communication protocol and a second communication module operating in compliance with a second wireless communication protocol. The first communication module transmits a protection frame and suspends performance of at least one radio activity after transmitting the protection frame. A duration field of the protection frame is set based on a predetermined duration determined according to a time required for preforming one or more radio activities of the second communication module. The second communication module performs at least a transmitting activity within the predetermined duration after the first communication module has transmitted the protection frame.

According to another embodiment of the invention, an electronic device comprises a first communication module operating in compliance with a first wireless communication protocol and a second communication module operating in compliance with a second wireless communication protocol. The first communication module transmits a protection frame at a predetermined channel and suspends performance of at least one radio activity after transmitting the protection frame. A duration field of the protection frame is set based on a predetermined duration determined according to a time required for preforming one or more radio activities of the second communication module. The second communication module performs at least a transmitting activity at the predetermined channel within the predetermined duration after the first communication module has transmitted the protection frame.

According to yet another embodiment of the invention, an electronic device comprises a Wi-Fi module operating in compliance with a Wi-Fi protocol and a Radar module operating in compliance with a Radar protocol. The Wi-Fi module transmits a protection frame at a predetermined channel and suspends performance of at least one radio activity after transmitting the protection frame. A duration field of the protection frame is set based on a predetermined duration determined according to a time required for preforming one or more radio activities of the Radar module. The Radar module performs at least a transmitting activity at the predetermined channel within the predetermined duration after the Wi-Fi module has transmitted the protection frame.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exemplary block diagram of an electronic device according to an embodiment of the invention.

FIG. 2 is a table showing a list of Wi-Fi channels with 20 MHz bandwidth on the 5 GHz operation frequency band.

FIG. 3 is a schematic diagram showing an implementation of periodically transmitting Wi-Fi control frame to protect periodic Radar transmissions according to an embodiment of the invention.

FIG. 4 is an exemplary hardware structure of the Wi-Fi module and the Radar module sharing the antennas and the front-end circuits according to an embodiment of the invention.

### DETAILED DESCRIPTION

According to an embodiment of the invention, an electronic device comprises a first communication module operating in compliance with a first wireless communication protocol and a second communication module operating in compliance with a second wireless communication protocol. The electronic device implements an interference protection mechanism by transmitting a protection frame.

To be more specific, the first communication module may transmit a protection frame for the second communication module, and then suspend performance of at least one radio activity after transmitting the protection frame.

According to an embodiment of the invention, the radio activity performed by a communication module may be a transmitting activity to transmit a radio frequency (RF) signal to the air interface or a receiving activity to receive an RF signal from the air interface.

According to an embodiment of the invention, to prevent the radio activity of the second communication module from being interfered by other signal transmitted at the same time in the air, a duration field of the protection frame is set based on a predetermined duration determined according to a time required for preforming one or more radio activities of the second communication module. The second communication module may perform at least a transmitting activity within the predetermined duration after the first communication module has transmitted the protection frame.

According to an embodiment of the invention, the first wireless communication protocol is a Wi-Fi protocol and the second wireless communication protocol is a Radar protocol.

According to an embodiment of the invention, the protection frame is transmitted at an operation frequency of the second communication module.

According to an embodiment of the invention, the protection frame is transmitted at one or more channels, and a frequency range of the one or more channels covers an operation frequency band of the second communication module.

According to an embodiment of the invention, the protection frame is transmitted at one or more channels, and an operation frequency band of the second communication module covers a frequency range of the one or more channels.

According to an embodiment of the invention, the protection frame is transmitted at multiple channels at the same time.

According to an embodiment of the invention, the first communication module performs one or more radio activities at a first frequency band, the second communication module performs the one or more radio activities at a second frequency band, and the first frequency band and the second frequency band are overlapped.

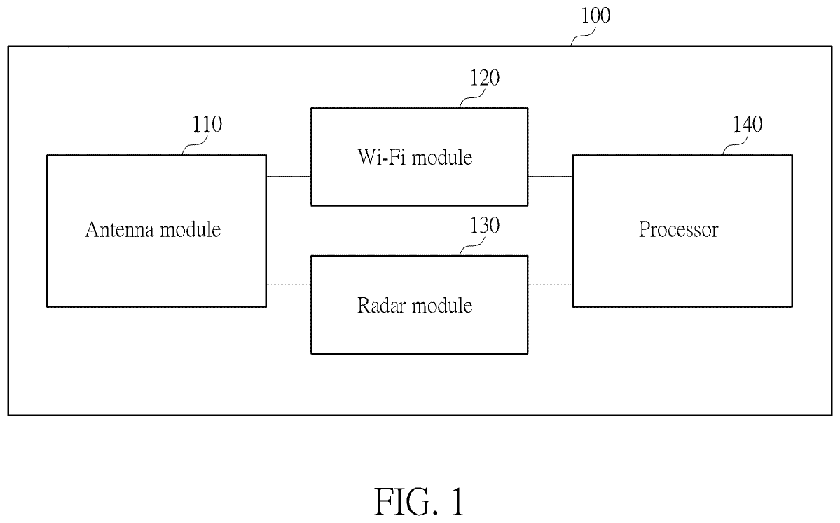

FIG. 1 is an exemplary block diagram of an electronic device according to an embodiment of the invention. The electronic device 100 comprises an antenna module 110, a Wi-Fi module 120, a Radar module 130 and a processor 140. The antenna module 110 is shared by the Wi-Fi module 120 and the radar module 130 and comprises one or more antennas and one or more front-end circuits for performing front-end signal processing. The Wi-Fi module 120 operates in compliance with a Wi-Fi protocol. The Radar module 130 operates in compliance with a Radar protocol. The processor 140 controls the overall operations of the electronic device 100, including the controls of the Wi-Fi module 120 and the Radar module 130.

Note that in order to clarify the concept of the invention, FIG. 1 presents a simplified block diagram of an electronic device in which only the components relevant to the invention are shown. As will be readily appreciated by a person of ordinary skill in the art, an electronic device may further comprise other components not shown in FIG. 1 and configured for implementing the functions of wireless communication and related signal processing.

Note further that in some embodiments of the invention, the processor 140 may be integrated in the Wi-Fi module 120 or the Radar module 130. That is, the processor 140 may be comprised in the Wi-Fi module 120 or the Radar module 130 as the processor thereof. The invention is not limited to any specific implementations.

According to an embodiment of the invention, the Wi-Fi module 120 may transmit the protection frame at a predetermined channel and suspends performance of at least one radio activity after transmitting the protection frame. A duration field of the protection frame is set based on a predetermined duration determined according to a time required for preforming one or more radio activities of the Radar module 130.

After the Wi-Fi module 120 has transmitted the protection frame, the Radar module 130 may perform at least a transmitting activity at the predetermined channel within the predetermined duration.

For any devices or stations listening on the wireless medium of wireless communication in the wireless communication environment, upon receiving the protection frame transmitted by the Wi-Fi module 120, the devices or stations will defer from accessing the medium within the duration indicated by the protection frame, thereby the radio activity performed by the Radar module 130 within the duration is protected.

To be more specific, with the duration information obtained from the duration field of a received frame, e.g., the aforementioned protection frame, a device or station may configure a Network Allocation Vector (NAV) based on the duration information. The NAV is a virtual carrier-sensing mechanism used with wireless network protocols such as IEEE 802.11 (Wi-Fi). The Medium Access Control (MAC) layer frame headers contain the duration field that specifies the transmission time required for the frame. The devices or stations listening on the wireless medium of the wireless communication environment read the duration field to obtain the duration information and set their NAV, which is an indicator for a device or a station on how long it must defer from accessing the medium, according to the duration information.

In this manner, interference from other devices transmitting signals at the same time in the air can be prevented and performance of the radio activity of the Radar module 130 can be protected.

According to an embodiment of the invention, the protection frame is transmitted at an operation frequency of the Radar module 130.

According to an embodiment of the invention, the protection frame is transmitted at one or more channels, and a frequency range of the one or more channels covers an operation frequency band of the Radar module 130.

According to an embodiment of the invention, the protection frame is transmitted at one or more channels, and an operation frequency band of the Radar module 130 covers a frequency range of the one or more channels.

According to an embodiment of the invention, the protection frame is transmitted by the Wi-Fi module 120 at multiple Wi-Fi channels at the same time.

According to an embodiment of the invention, the Wi-Fi module 120 performs one or more radio activities at a first frequency band, the Radar module 130 performs the one or more radio activities at a second frequency band, and the first frequency band and the second frequency band are overlapped.

Note that in the embodiments of the invention, the Wi-Fi operation frequency band and the Radar operation frequency band may be determined based on country region channel rules. Therefore, the frequency or channel at which the protection frame is transmitted may be determined based on country region channel rules as well.

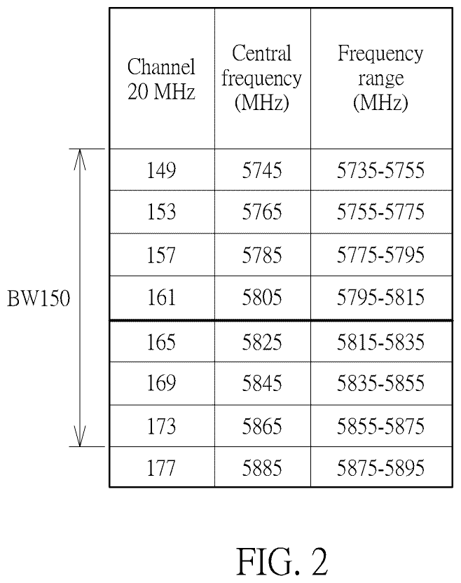

FIG. 2 is a table showing a list of Wi-Fi channels with 20 MHz bandwidth on the 5 GHz operation frequency band. In FIG. 2, the frequency ranges and central frequencies of the Wi-Fi channels having the indices from 149 to 177 are shown. The operation frequency band of the Radar module with a 150 MHZ bandwidth (labeled by BW 150) is also shown on the left side of FIG. 2.

In this embodiment, the Radar module 130 may perform radio activities at the frequency band from 5725 MHz to 5875 MHz and the Wi-Fi module 120 may perform radio activities at the frequency band at least from 5735 MHz to 5895 MHz. Therefore, an operation frequency band of the Radar module 130 covers a frequency range of the Wi-Fi channels 149-173, or, the frequency range of the Wi-Fi channels 149-177 covers an operation frequency band of the Radar module 130.

According to an embodiment of the invention, the protection frame is transmitted at the operation frequency of the Radar module 130 which may be within the range from 5725 MHz to 5875 MHz.

According to an embodiment of the invention, the protection frame is transmitted at one or more of the Wi-Fi channels 149-173, which overlaps the operation frequency of the Radar module 130.

According to an embodiment of the invention, the protection frame transmitted by the Wi-Fi module 120 for the Radar module 130 to perform one or more radio activities without interference is a Clear-to-send-to-self (CTS2Self) frame. According to another embodiment of the invention, the protection frame transmitted by the Wi-Fi module 120 for the Radar module 130 may be other frame, such as a Wi-Fi control frame or a Wi-Fi management frame.

According to an embodiment of the invention, the Wi-Fi module 120 may periodically transmit the protection frame. According to another embodiment of the invention, the Wi-Fi module 120 may aperiodically transmit the protection frame.

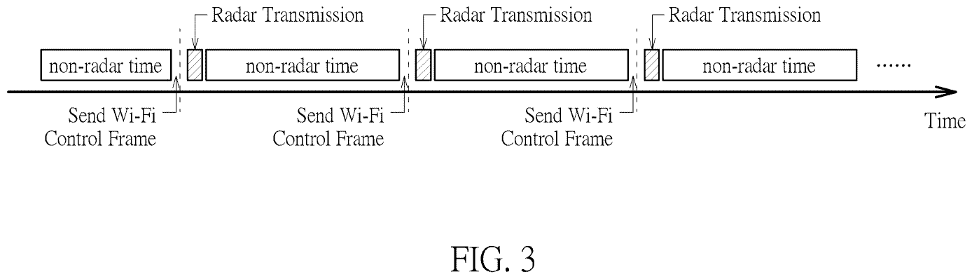

FIG. 3 is a schematic diagram showing an implementation of periodically transmitting Wi-Fi control frame to protect periodic Radar transmissions according to an embodiment of the invention. In this embodiment, the Wi-Fi module operates in the “non-radar time”. The Wi-Fi module may perform its radio activities to communicate with other devices or stations during the “non-radar time”. At the end of the “non-radar time”, the Wi-Fi module may send a Wi-Fi control frame to protect the forthcoming radar transmission, and then suspend its radio activities during the Radar transmission time.

The Radar module may perform its radio activities during the Radar transmission time. For example, the Radar module may transmit a detection signal or a detection frame and receive the detection signal or the detection frame transmitted by itself, so as to implement the aforementioned functions such as human presence sensing, gesture sensing, non-contact health monitoring, . . . etc.

After the Radar transmission time, the Wi-Fi module may resume its radio activities in the next “non-radar time”, and send another Wi-Fi control frame to protect the forthcoming radar transmission at the end of the “non-radar time”. The operations of switching the performance of radio activities between Wi-Fi module and Radar module may be repeated.

According to an embodiment of the invention, the antenna module is shared by the Wi-Fi module and the Radar module, such as the antenna module 110 being shared by the Wi-Fi module 120 and the Radar module 130 as shown in FIG. 1.

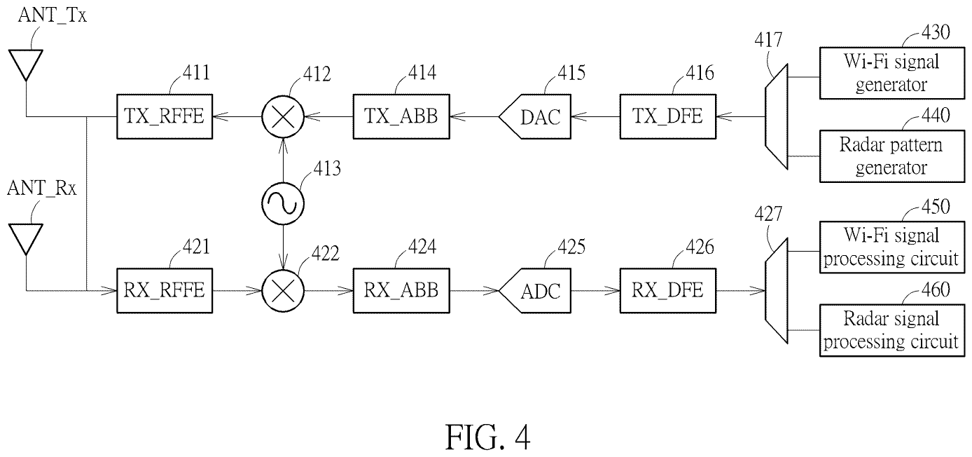

FIG. 4 is an exemplary hardware structure of the Wi-Fi module and the Radar module sharing the antennas and the front-end circuits according to an embodiment of the invention. In this embodiment, the antennas in the antenna module comprise at least a transmitting antenna ANT_Tx and a receiving antenna ANT_Rx.

The front-end circuits on the transmitting signal processing path may comprise a transmitter radio frequency front-end circuit TX_RFFE 411, a mixer 412, an oscillator 413, a transmitter analogy baseband circuit TX_ABB 414, a digital to analog converter (DAC) 415, a transmitter digital front-end circuit TX_DFE 416 and a multiplexer 417. The multiplexer 417 is coupled to a Wi-Fi signal generator 430 and a Radar pattern generator 440. The Wi-Fi signal generator 430 may be comprised in the Wi-Fi module (such as the Wi-Fi module 120 shown in FIG. 1). The Radar pattern generator 440 may be comprised in the Radar module (such as the Radar module 130 shown in FIG. 1).

The Wi-Fi signal generator 430 generates and encodes Wi-Fi signals to be transmitted. The Radar pattern generator 440 generates and encodes Radar waveforms, which can be any waveform used in Radar, to be transmitted. The multiplexer 417 selectively outputs the Wi-Fi signals and Radar waveforms according to a control signal (not shown). The TX_DFE 416 performs digital front-end signal processing, such as spectrum shaping, impairment compensation, . . . etc., on the received signals. The DAC 415 converts the received signals from digital domain to analog domain. The TX_ABB 414 performs analog baseband signal processing, such as waveform shaping, magnitude adjustment, . . . etc., on the received signals. The mixer 412 performs frequency up conversion on the received signals based on the oscillating signal generated by the oscillator 413. The TX_RFFE 411 performs RF front-end signal processing on the received signals, such as adjusting the power radiation of the analog waveform in the radio frequency band.

The front-end circuits on the receiving signal processing path may comprise a receiver radio frequency front-end circuit RX_RFFE 421, a mixer 422, the oscillator 413, a receiver analogy baseband circuit RX_ABB 424, an analog to digital converter (ADC) 425, a receiver digital front-end circuit RX_DFE 426 and a demultiplexer 427. The demultiplexer 427 is coupled to a Wi-Fi signal processing circuit 450 and a Radar signal processing circuit 460. The Wi-Fi signal processing circuit 450 may be comprised in the Wi-Fi module (such as the Wi-Fi module 120 shown in FIG. 1). The Radar signal processing circuit 460 may be comprised in the Radar module (such as the Radar module 130 shown in FIG. 1).

The RX_RFFE 421 performs RF front-end signal processing on the received signals, such as adjusting the power or amplitude of the received signal. The mixer 422 performs frequency down conversion on the received signals based on the oscillating signal generated by the oscillator 413. The RX_ABB 424 performs analog baseband signal processing, such as waveform shaping, magnitude adjustment, . . . etc., on the received signals. The ADC 425 converts the received signals from analog domain to digital domain. The RX_DFE 426 performs digital front-end signal processing, such as spectrum shaping, receiver impairment compensation, . . . etc., on the received signals. The demultiplexer 427 selectively outputs the received signal to the Wi-Fi signal processing circuit 450 and the Radar signal processing circuit 460. The Wi-Fi signal processing circuit 450 demodulates and decodes the received Wi-Fi signal, and performs subsequent signal processing. The Radar signal processing circuit 460 extracts the Radar waveforms from the received signal, and performs subsequent signal processing, such as analyzing the Radar waveforms to detect an object surrounding, estimate the object distance and monitor the movement of the object.

According to an embodiment of the invention, when switching the performance of radio activities between the Wi-Fi module (e.g., the Wi-Fi module 120) and the Radar module (e.g., the Radar module 130) (for example, switching the right of using the antenna module (e.g., the antenna module 110) to perform the corresponding radio activities), the processor (e.g., the processor 140) or the Wi-Fi module may back up the associated channel information.

For example, before sending the protection frame, the Wi-Fi module may back up the current channel information and stop processing any Wi-Fi Tx packet. In addition, the Wi-Fi module may set the antenna module to the channel for transmitting the protection frame (for example, set the channel for transmitting the protection frame based on the operation frequency of the Radar module) and then transmit the protection frame at the operation frequency of the Radar module.

After transmitting the protection frame, the Wi-Fi module may suspend performance of at least one radio activity, for example, the Wi-Fi module may lock its Tx and Rx operations.

The processor may then set the antenna module based on the operation frequency or channel of the Radar module, and the Radar module performs its radio activities. After the Radar operation is completed, the processor or the Wi-Fi module may set back the antenna module based on the backed-up channel information of the Wi-Fi module and resume the Tx and Rx operations of the Wi-Fi module. In addition, after the Radar operation is completed, the Radar module may perform subsequent signal processing, such as analyzing the Radar waveforms, to detect an object surrounding, estimate the object distance and monitor the movement of the object.

In the embodiments of the invention, by transmitting a protection frame through the first communication module for the second communication module as introduced above, interference from other devices can be prevented and performance of the radio activity of the second communication module can be protected.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device, comprising:
a first communication module, operating in compliance with a first wireless communication protocol; and
a second communication module, operating in compliance with a second wireless communication protocol,
wherein the first communication module transmits a protection frame and suspends performance of at least one radio activity after transmitting the protection frame,
wherein a duration field of the protection frame is set based on a predetermined duration determined according to a time required for preforming one or more radio activities of the second communication module, and
wherein the second communication module performs at least a transmitting activity within the predetermined duration after the first communication module has transmitted the protection frame.

2. The electronic device of claim 1, wherein the protection frame is transmitted at an operation frequency of the second communication module.

3. The electronic device of claim 1, wherein the protection frame is transmitted at one or more channels, and wherein a frequency range of the one or more channels covers an operation frequency band of the second communication module.

4. The electronic device of claim 1, wherein the protection frame is transmitted at one or more channels, and wherein an operation frequency band of the second communication module covers a frequency range of the one or more channels.

5. The electronic device of claim 1, wherein the first communication module performs one or more radio activities at a first frequency band, the second communication module performs the one or more radio activities at a second frequency band, and wherein the first frequency band and the second frequency band are overlapped.

6. The electronic device of claim 1, wherein the first communication module periodically transmits the protection frame.

7. The electronic device of claim 1, wherein the first wireless communication protocol is a Wi-Fi protocol and the second wireless communication protocol is a Radar protocol.

8. The electronic device of claim 1, wherein the protection frame is a Clear-to-send-to-self (CTS2Self) frame.

9. An electronic device, comprising:
a first communication module, operating in compliance with a first wireless communication protocol; and
a second communication module, operating in compliance with a second wireless communication protocol,
wherein the first communication module transmits a protection frame at a predetermined channel and suspends performance of at least one radio activity after transmitting the protection frame,
wherein a duration field of the protection frame is set based on a predetermined duration determined according to a time required for preforming one or more radio activities of the second communication module, and
wherein the second communication module performs at least a transmitting activity at the predetermined channel within the predetermined duration after the first communication module has transmitted the protection frame.

10. The electronic device of claim 9, wherein the first communication module performs one or more radio activities at a first frequency band, the second communication module performs the one or more radio activities at a second frequency band, and wherein the first frequency band and the second frequency band are overlapped.

11. The electronic device of claim 9, wherein the first communication module periodically transmits the protection frame.

12. The electronic device of claim 9, wherein the first wireless communication protocol is a Wi-Fi protocol and the second wireless communication protocol is a Radar protocol.

13. The electronic device of claim 9, wherein the protection frame is a Clear-to-send-to-self (CTS2Self) frame.

14. An electronic device, comprising:
a Wi-Fi module, operating in compliance with a Wi-Fi protocol; and
a Radar module, operating in compliance with a Radar protocol,
wherein the Wi-Fi module transmits a protection frame at a predetermined channel and suspends performance of at least one radio activity after transmitting the protection frame,
wherein a duration field of the protection frame is set based on a predetermined duration determined according to a time required for preforming one or more radio activities of the Radar module, and
wherein the Radar module performs at least a transmitting activity at the predetermined channel within the predetermined duration after the Wi-Fi module has transmitted the protection frame.

15. The electronic device of claim 14, wherein the protection frame is a Clear-to-send-to-self (CTS2Self) frame.
